(19) United States
(12) Patent Application Publication
(10) Pub. No.: US 2011/0159761 A1
(43) Pub. Date: Jun. 30, 2011

(54) COPPER CLAD LAMINATE AND IMPREGNATION LIQUID FOR MAKING THE SAME

(75) Inventors: Joseph Yang, Taipei City (TW); CC Chou, Hsinchu County (TW); Peter Ho, Taichung County (TW); Willis Tang, Taichung City (TW)

(73) Assignee: SIBELCO BAO LIN CO., LTD., Taichung City (TW)

(21) Appl. No.: 12/649,065

(22) Filed: Dec. 29, 2009

(51) Int. Cl. B32B 5/02

(52) U.S. Cl. 442/180; 524/430; 524/405; 524/433

(57) ABSTRACT

A copper clad laminate includes a glass fiber substrate and at least a copper foil on the glass fiber substrate. The glass fiber substrate is made by impregnating glass fiber fabrics in an impregnation liquid to form prepregs, and then the prepregs are laid up with a copper foil to form the copper clad laminate by a hot press molding. The impregnation liquid includes resin and a filler in a range between 5 PHR and 80 PHR, wherein the filler includes silica and at least a metallic oxide, of which a metallic atom is selected from the groups IIA or IIIA elements in the periodic table, to form a composite material with an amorphous network structure that the copper clad laminate will have a suitable hardness and a coefficient of thermal expansion.

### BACKGROUND OF THE INVENTION

1. Field of the Invention

The present invention relates generally to a circuit, and more particularly to a copper clad laminate and an impregnation liquid used in a process for making such copper clad laminate.

2. Description of the Related Art

Printed circuit board (PCB) has a substrate with predetermined pattern, on which electronic components are mounted to achieve predetermined function. Quality of PCB affects the reliability and the performance of electronic devices. Copper clad laminate (CCL) is the basic material of PCB which is made in a process of embedding insulating papers, glass fiber fabrics or other fiber material in epoxy or bakelite glue, forming a substrate when the prepreg is dried, cut and laminated, and finally, attaching the substrate with copper foil either on one side or on both sides by hot press molding. The CCL with glass fiber substrate is very popular because of its superior mechanic properties.

In the prior art, glass fiber base CCL is added with predetermined filler to improve the mechanic properties thereof. The most common filler is silica. Silica is a crystal of tetrahedral network. Use of silica as the filler will increase the rigidity of the substrate and decrease the Coefficient of thermal expansion. The substrate with high rigidity has an advantage of being difficult to warp; however, it makes the substrate hard to drill as well, and therefore drills for drilling holes on such substrate can be worn quickly. Additionally, uncleanly drilled hole produced in the drilling process also raises the defect rate. If the coefficient of thermal expansion of the filler is too high and is very different from those of other materials making the substrate, it will cause internal stress in the substrate. During the thermal cycles of the process, such substrate may have micro-crack and short circuit is possible. Silica as a predetermined filler has a quite low coefficient of thermal expansion. But if there is a filler with even lower coefficient of thermal expansion, it will much improve the problem of micro-crack and short circuit.

### SUMMARY OF THE INVENTION

The primary objective of the present invention is to provide copper clad laminate and an impregnation liquid for making it, in which the copper clad laminate has a suitable rigidity and coefficient of thermal expansion.

According to the objective of the present invention, a copper clad laminate includes a glass fiber substrate and at least a copper foil on the glass fiber substrate. The glass fiber substrate is made by impregnating glass fiber fabrics in an impregnation liquid to form prepregs, and then laying up the prepregs with a copper foil to form the copper clad laminate by a hot press molding. The impregnation liquid includes resin and a filler in a range between 5 PHR and 80 PHR, wherein the filler includes silica and at least a metallic oxide, of which a metallic element is selected from the groups IIA or IIIA in the periodic table, to form a composite material with an amorphous network structure that the copper clad laminate will have a suitable hardness and coefficient of thermal expansion.

### BRIEF DESCRIPTION OF THE DRAWINGS

FIG. 1 is a flow diagram of making copper clad laminate;

FIG. 2 shows the drilling performance, the drill image and the Cpk of the drilling process after predetermined number of drillings of the copper clad laminate sample A;

FIG. 3 shows the drilling performance, the drill image and the Cpk of the drilling process after predetermined number of drillings of the copper clad laminate sample B;

FIG. 4 shows the drilling performance, the drill image and the Cpk of the drilling process after predetermined number of drillings of the copper clad laminate sample C;

FIG. 5 shows the drilling performance, the drill image and the Cpk of the drilling process after predetermined number of drillings of the copper clad laminate sample D; and

FIG. 6 shows the drilling performance, the drill image and the Cpk of the drilling process after predetermined number of drillings of the copper clad laminate sample E.

### DETAILED DESCRIPTION OF THE INVENTION

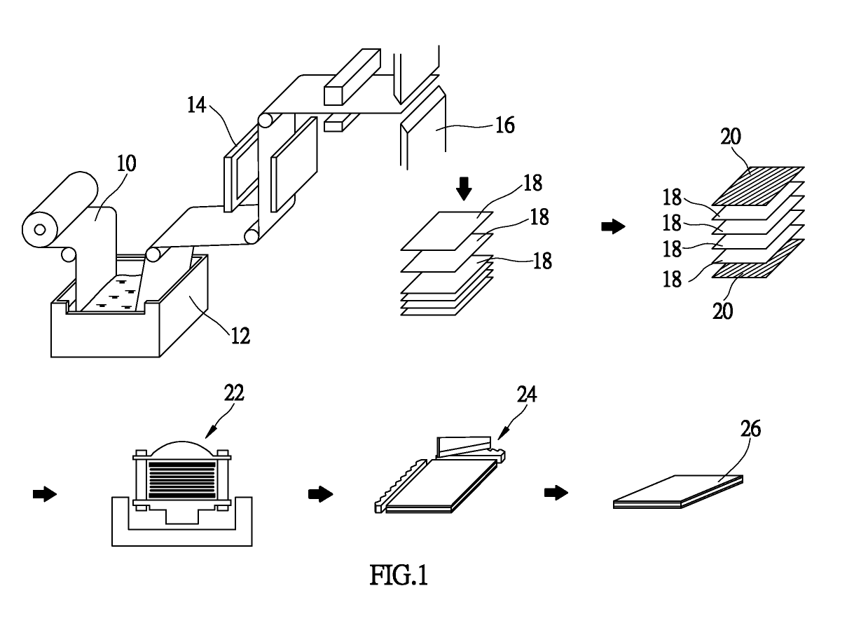

FIG. 1 shows the process of making glass fiber copper clad laminate which includes the following steps: impregnating a glass fiber fabric 10 in a tank 12, in which impregnation liquid is received, and then heating the impregnated glass fiber fabric 10 by an oven 14, and cutting it by a cutter 16 to form prepregs 18. Next, the prepregs 18 are laid up with predetermined fiber orientations and copper foils 20 are put on top and bottom of the prepregs 18 for the following hot press molding process 22. In hot press molding process 22, the prepregs 18 and the copper foils 20 are bound together to form a board, and then the board is trimmed to have a copper clad laminate 26 with a glass fiber substrate and copper foils on both sides. Such copper clad laminate 26 is composed of a plurality of prepregs 18 and at least one copper foil 20. The prepregs 18 are composed of the glass fiber fabrics 10 and impregnation material, which is cured impregnation liquid.

The main content of the present invention relates to the copper clad laminate and components of the impregnation liquid, which is used in the process of making the copper clad laminate of the present invention. The impregnation liquid of the present invention is mainly composed of resin (epoxy is used in the present invention) and 5˜80 PHR (Per Hundred Resin) filler. In other words, the percentage in weight of the resin and filler is 100:5˜80. The filler is composed of silica (SiO₂), Aluminium oxide (Al₂O₃), diboron trioxide (B₂O₃), Calcium oxide (CaO), Magnesium oxide (MgO), Strontium oxide (SrO), and Barium oxide (BaO) to form a composite material with an amorphous network structure. The major component of the filler of the present invention is silica, which is about 50 wt %˜80 wt %, and other metallic oxides are about 20 wt %'80 wt %.

Silica, the main component of the filler of the present invention, is a crystal of tetrahedral network structure to enhance the hardness of the substrate and lower the coefficient of thermal expansion thereof. The rest components of the filler of the present invention are metallic oxides, in which the metal elements are chosen from group IIA and group IIIA of periodic table. The metallic oxides will incorporate in the silica tetrahedral network. Some metallic atoms will replace silicon atoms so to break down the perfect tetrahedral network structure to form an amorphous composite material. Comparing with the crystalline silica, the amorphous composite material of the present invention has a lower hardness, and even comparing with the amorphous silica, the hardness of the filler of the present invention is also lower.

According to the tests of inventor of the present invention, when the metallic oxide is chosen from Aluminium oxide (Al₂O₃) and diboron trioxide (B₂O₃) of group IIIA elements, or Calcium oxide (CaO), Magnesium oxide (MgO), Strontium oxide (SrO), and Barium oxide (BaO) of group IIA elements, or a combination of two or more than two of above metallic oxides, it may decrease the hardness of the substrate to lower the wearing of drill. Furthermore, when the metallic oxide is chosen from Aluminium oxide (Al₂O₃) and diboron trioxide (B₂O₃) of group IIIA element, or Calcium oxide (CaO), and Magnesium oxide (MgO) of group IIA element, or a combination of two or more than two of above metallic oxides, it also decreases the coefficient of thermal expansion.

Therefore, to be applied in copper clad laminate, the filler is preferred to be silica based with the following oxides added: Aluminium oxide (Al₂O₃) and diboron trioxide (B₂O₃) of group IIIA element, or Calcium oxide (CaO), and Magnesium oxide (MgO) of group IIIA element. In addition to hardness and coefficient of thermal expansion, when consider other applied properties for example chemical durability and dielectric constant, preferred percentages in weight of the components of the filler of the present invention are 50˜62% silica (SiO₂), 11˜19% Aluminium oxide (Al₂O₃), 4˜13% diboron trioxide (B₂O₃), 6˜27% Calcium oxide (CaO), <6% Magnesium oxide (MgO), <1.5% Strontium oxide (SrO), and <0.1% Barium oxide (BaO).

The comparison of the copper clad laminate with practiced silica filler with the copper clad laminate with the amorphous composite material filler of the present invention is listed in following tables.

### Example 1

### Sample A

### The Recipe of the Practiced Impregnation Liquid without Filler

| | | |
|---|---|---|
| Epoxy PE335 | 100 | PHR |
| Dicyandiamide | 2 | PHR |
| 2-methylimidazole | 0.15 | PHR |
| DMF | | |

In impregnation, the glass fiber fabric is 7628. After impregnation, the impregnated glass fiber fabric is cured under 170 for 3 minutes. After that, five glass fiber fabrics are laid up with 0.5 oz/ft² copper foils on opposite sides thereof, and then is heated to 170 for an hour to form a copper clad laminate with 0.95 mm thickness.

Above copper clad laminate is used in the tests, and the test's results are listed as following:

| | | |
|---|---|---|
| Solder float at 288 | >180 | sec |
| Peel strength | 1.3 | kgf/cm |
| Glass transition temperature (Tg(1)) | 152.9° | C. |
| CTE < Tg | 45.4 | ppm/° C. |
| CTE > Tg | 256.8 | ppm/° C. |
| Δ % (50~260) | 3.30% | |

### Sample B

### The Recipe of Impregnation Liquid with Practiced Silica Filler

| | | |
|---|---|---|
| Epoxy PE335 | 100 | PHR |
| Dicyandiamide | 2 | PHR |
| 2-methylimidazole | 0.15 | PHR |
| DMF | | |
| Filler D50 = 2 μm silica | 25 | PHR |

After being laid up with copper foils and hot press molding, the properties are:

| | | |
|---|---|---|
| Solder float at 288 | >180 | sec |
| Peel strength | 1.3 | kgf/cm |
| Glass transition temperature (Tg(1)) | 153.4° | C. |
| CTE < Tg | 39.6 | ppm/° C. |
| CTE > Tg | 217.2 | ppm/° C. |
| Δ % (50~260) | 2.78% | |

Comparing Sample A with Sample B, it is obvious that Sample B has a higher Tg and lower coefficient of thermal expansion when 2 μm silica is added.

### Sample C

### Using the Same Recipe of Impregnation Liquid as in Sample B and Replace the Silica Filler (D50=2 μm) with Amorphous Composite Material with the Following Composition

| | |
|---|---|
| silica (SiO₂) | 60.5% |
| Aluminium oxide (Al₂O₃) | 17% |
| diboron trioxide (B₂O₃) | 11.95% |
| Calcium oxide (CaO) | 7.8% |
| Magnesium oxide (MgO) | 1.9% |
| Strontium oxide (SrO) | 0.85% |
| Barium oxide (BaO) | <0.1% |

After being laid up with copper foils and hot press molding, the properties are:

| | | |
|---|---|---|
| Solder float at 288 | >180 | sec |
| Peel strength | 1.3 | kgf/cm |
| Glass transition temperature (Tg(1)) | 153.2° | C. |
| CTE < Tg | 38.3 | ppm/° C. |
| CTE > Tg | 212.4 | ppm/° C. |
| Δ % (50~260) | 2.54% | |

In conclusion, when the composite material filler of the present invention is added, the substrate has a lower coefficient of thermal expansion than that of the substrate added with the practiced silica filler.

### Example 2

### Sample D

### The Recipe of the Impregnation Liquid is the Same as Sample B Except the Filler PHR

| | | |
|---|---|---|
| Epoxy PE335 | 100 | PHR |
| Dicyandiamide | 2 | PHR |
| 2-methylimidazole | 0.15 | PHR |
| DMF | | |
| Filler D50 = 2 μm silica | 66 | PHR |

After being laid up with copper foils and hot press molding, the properties are:

| | | |
|---|---|---|
| Solder float at 288 | >180 | sec |
| Peel strength | 1.3 | kgf/cm |
| Glass transition temperature (Tg(1)) | 154.6° | C. |
| CTE < Tg | 35.4 | ppm/° C. |
| CTE > Tg | 186.5 | ppm/° C. |
| Δ % (50~260) | 2.42% | |

### Sample E

### Using the Same Recipe of Impregnation Liquid as in Sample D and Replace the Silica Filler (D50=2 μm) with Amorphous Composite Material with the Following Composition

| | |
|---|---|
| silica (SiO₂) | 52% |
| Aluminium oxide (Al₂O₃) | 12% |
| diboron trioxide (B₂O₃) | 5% |
| Calcium oxide (CaO) | 26% |
| Magnesium oxide (MgO) | 5% |

After being laid up with copper foils and hot press molding, the properties are:

| | | |
|---|---|---|
| Solder float at 288 | >180 | sec |
| Peel strength | 1.3 | kgf/cm |
| Glass transition temperature (Tg(1)) | 154.2° | C. |
| CTE < Tg | 34.7 | ppm/° C. |
| CTE > Tg | 179.9 | ppm/° C. |
| Δ % (50~260) | 2.29% | |

We find that higher PHR of filler makes higher Tg and lower coefficient of thermal expansion, and the effect is even more pronounced when using the amorphous composite material of the present invention as the filler.

### Example 3

The copper clad laminates of samples A, B, C, D, and E are used in drilling test, and the result of the test is listed in the following table:

| Sample | A | | B | | C | | D | | E | |
|---|---|---|---|---|---|---|---|---|---|---|
| Epoxy PE335 | 100 | PHR | 100 | PHR | 100 | PHR | 100 | PHR | 100 | PHR |
| Dicyandiamide | 2 | PHR | 2 | PHR | 2 | PHR | 2 | PHR | 2 | PHR |
| 2-methylimidazole | 0.15 | PHR | 0.15 | PHR | 0.15 | PHR | 0.15 | PHR | 0.15 | PHR |
| DMF | | | | | | | | | | |
| D50 = 2 μm silica | | | 25 | PHR | | | 66 | PHR | | |
| D50 = 2 μm amorphous | | | | | 25 | PHR | | | 66 | PHR |
| composite material | | | | | | | | | | |

Composition of silica and the amorphous composite material are same as above examples, and the conditions of impregnation and hot press molding are kept no change, the drilling condition is:

| | |
|---|---|
| Drill bit | Wellink 0.25 mm |
| Drilling numbers | 1,000, 2,000, 3,000, 4,000, and 5,000 |
| | 6 drill bits are tested for each defined |
| | drilling numbers |
| Lay-up mode | two test pieces in one stack for drilling |
| Aluminum board | LE-400 |
| Speed of drilling | 200,000 rpm |
| Speed of feeding forward | 138 inch/min |
| Speed of feeding backward | 948 inch/min |

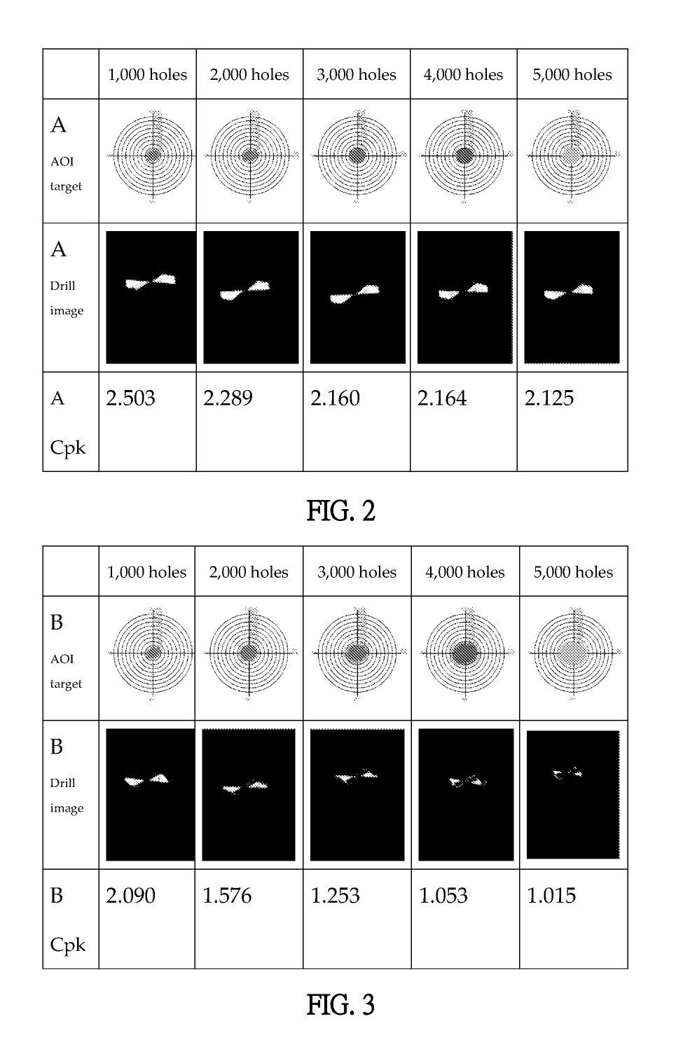

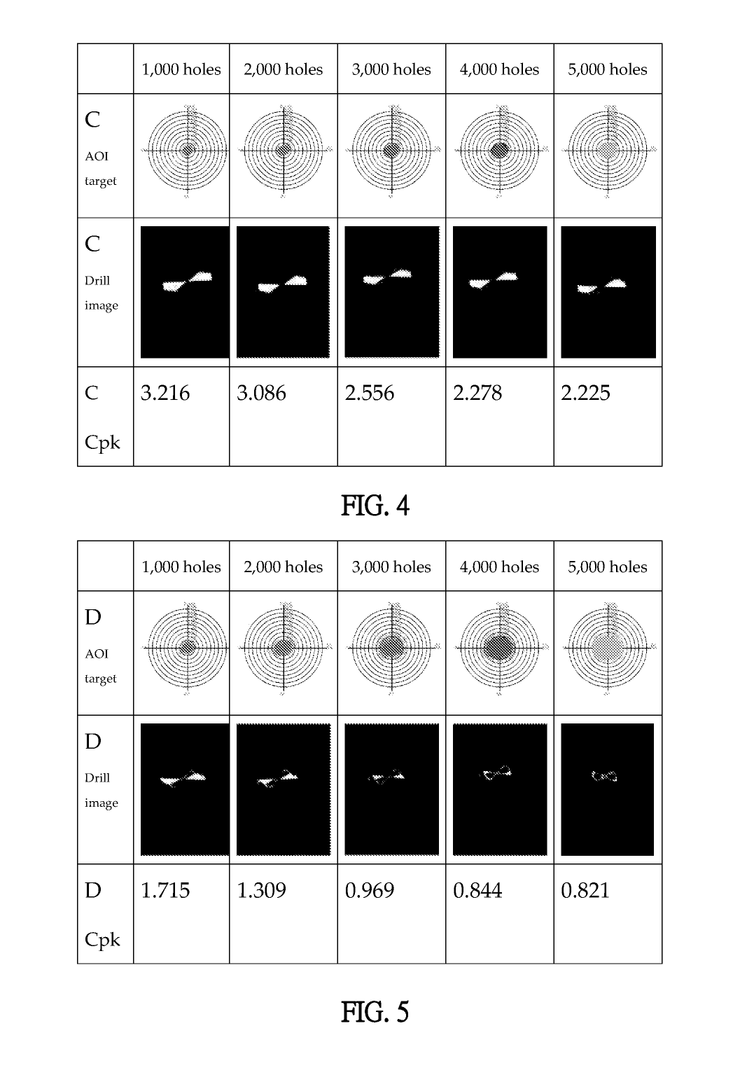

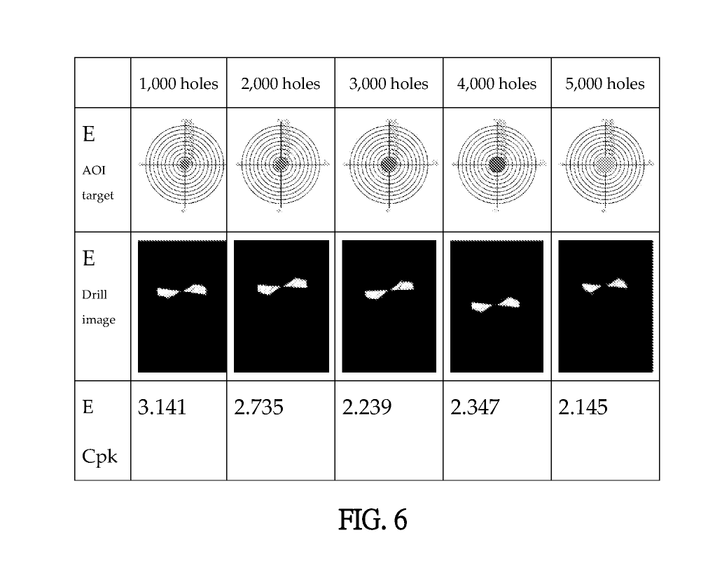

The drilling process capability and wearing condition of drills of samples A˜E are shown in FIG. 2 to FIG. 6. For calculation of the drilling process capability, the specification center (0,0) is defined as the average (X, Y) position after defined drilling numbers, and the upper and lower specification of X axis and Y axis are ±2 mm. The wearing condition of drill is shown by the AOI (Automated optical inspection) image.

From FIG. 2 to FIG. 6, it shows that in spite of the difference in recipe or filler the higher the drilling numbers, the more the worn out of the drilling bit. More serious worn out causes more unbalanced vibration during the drilling and poor drilling process capability, lower Cpk value.

If the filler is practiced silica, the drilling is more difficult and the drill worn out is more serious because of higher hardness of silica, furthermore, the higher the drilling number, the deterioration of the process capability will be more obvious. The more the silica is added, the worse the conditions will be.

For the filler of the amorphous composite material of the present invention, the substrate made has a lower hardness than that made from the silica filler because of the amorphous structure of the composite material. The wearing condition of the drill and the drilling process capability is almost the same as the substrate without filler so as to provides a well drilling precision. The more the filler content, the more pronounced the effect of low worn out and good drilling process capability.

The description above is a few preferred embodiments of the present invention and the equivalence of the present invention is still in the scope of the claim of the present invention.

1. An impregnation liquid, which is used in a process of making copper clad laminates to impregnate glass fiber fabrics therein to form prepregs, and then the prepregs are combined with a copper foil to form the copper clad laminate by a hot press molding, comprising resin and a filler in a range between 5 PHR and 80 PHR, wherein the filler includes crystalline silica and at least a metallic oxide to form a composite material with an amorphous network structure, and the crystalline silica is in a range between 50 wt % and 80 wt %, and the metallic oxide is in a range between 20 wt % and 50 wt %.

2. The impregnation liquid as defined in claim 1, wherein the metallic oxide contains a metallic atom from the group IIA elements in the periodic table.

3. The impregnation liquid as defined in claim 1, wherein the metallic oxide contains a metallic atom from the group IIIA elements in the periodic table.

4. The impregnation liquid as defined in claim 1, wherein the metallic oxide contains a metallic atom from the group IIA elements or from the group IIIA elements in the periodic table.

5. The impregnation liquid as defined in claim 1, wherein the metallic oxide is a combination of at least a first metallic oxide, of which a metallic atom is selected from the group IIA elements in the periodic table, and at least a second metallic oxide, of which a metal is selected from the group IIIA elements in the periodic table.

6. The impregnation liquid as defined in claim 5, wherein the first metallic oxide is selected from the group consisting of Aluminium oxide (Al₂O₃) and diboron trioxide (B₂O₃), and the second metallic oxide is selected from a group consisting of Calcium oxide (CaO), Magnesium oxide (MgO), Strontium oxide (SrO), and Barium oxide (BaO).

7. The impregnation liquid as defined in claim 6, wherein the filler includes crystalline silica (SiO₂) in a range between 50% and 62%, Aluminium oxide (Al₂O₃) in a range between 11% and 19%, diboron trioxide (B₂O₃) in a range between 4% and 13%, Calcium oxide (CaO) in a range between 6% and 27%, Magnesium oxide (MgO) less than 6%, Strontium oxide (SrO) less than 1.5%, and Barium oxide (BaO) less than 0.1%.

8. A copper clad laminate comprising a glass fiber substrate and at least a copper foil on the glass fiber substrate, wherein the glass fiber substrate includes at least a glass fiber fabric and an impregnation material, which includes resin and a filler in a range between 5 PHR and 80 PHR, and wherein the filler includes crystalline silica and at least a metallic oxide to form a composite material with an amorphous network structure.

9. The copper clad laminate as defined in claim 8, wherein the metallic oxide contains a metallic atom from the group IIA elements in the periodic table.

10. The copper clad laminate as defined in claim 8, wherein the metallic oxide contains a metallic atom from the group IIIA elements in the periodic table.

11. The copper clad laminate as defined in claim 8, wherein the metallic oxide contains a metallic atom from the group IIA elements or from the group IIIA elements in the periodic table.

12. The copper clad laminate as defined in claim 8, wherein the metallic oxide is a combination of at least a first metallic oxide, of which a metal is selected from the group IIA elements in the periodic table, and at least a second metallic oxide, of which a metal is selected from the group IIIA elements in the periodic table.

13. The copper clad laminate as defined in claim 12, wherein the first metallic oxide is selected from the group consisting of Aluminium oxide (Al₂O₃) and diboron trioxide (B₂O₃), and the second metallic oxide is selected from a group consisting of Calcium oxide (CaO), Magnesium oxide (MgO), Strontium oxide (SrO), and Barium oxide (BaO).

14. The impregnation liquid as defined in claim 13, wherein the filler includes crystalline silica (SiO₂) in a range between 50% and 62%, Aluminium oxide (Al₂O₃) in a range between 11% and 19%, diboron trioxide (B₂O₃) in a range between 4% and 13%, Calcium oxide (CaO) in a range between 6% and 27%, Magnesium oxide (MgO) less than 6%, Strontium oxide (SrO) less than 1.5%, and Barium oxide (BaO) less than 0.1%.
